(19) United States
(12) Patent Application Publication
(10) Pub. No.: US 2004/0204913 A1
(43) Pub. Date: Oct. 14, 2004

(54) Optimizing service system

(76) Inventors: Peter Mueller, Dossenheim (DE); Jochen Schneider, Winterthur (SE); Andreas Zehnpfund, Frankfurt (DE)

Correspondence Address: Michael M. Rickin, Esq., ABB Inc., Legal Department - 4U6, 29801 Euclid Avenue, Wickliffe, OH, 44092-2530, US

(21) Appl. No.: 10/410,111

(22) Filed: Apr. 9, 2003

(51) Int. Cl. G06F 11/00

(52) U.S. Cl. 702/188; 702/189

(57) ABSTRACT

The invention refers to a service system for remote monitoring, control and optimization of at least one technical plant (3) and/or at least one therewith executed technical process (13.1 to 13.n). Thereby is one service server (1) connected to an automation system (2) respectively. A service client (4) equipped with control and display means is present, which can be connected to the respective service server (1) using a network connection (5) or to the optimization server (7), where the optimization server (7) is connected to the respective service server (1) of multiple technical plants (3). Each service server (1) is set up with a data interface (12), basic services (8), and application programs (9, 10, 11) to retrieve, save and process plant-based, control system-based or process-based data from the respective automation system (2).

The invention refers to a service system for remote control, remote operation, and remote optimization of at least one technical plant and/or at least one therewith executed technical process.

A known method to conduct service at a plant is to either station service personnel on site or send service personnel to the plant if needed.

Known is also the viewing of process values of a remote plant over a network connection as for instance described in Itschner, R.; Pommerell, C.; Rutishauser, M: Remote Monitoring of Embedded Systems in Power Engineering; IEEE Internet Computing, Vol. 2, No. 3, May/June 1998. Plants are already operated from remotely stationed personnel too. This is described in Bernhard Stang: Integrierte Fernwartungssysteme, in Brennstoff, Wärme, Kraft (BWK), Bd. 19 (1997), Nr. 9/10, pp. 49ff. However, an automated analysis and optimization of the plant and process state at the site of the plant is not possible with that.

The concept of on-site service that is used nowadays has the disadvantage that the service personnel has to be at the plant in order to carry out their work. Especially with process optimization and complicated analyses qualified personnel is bound then and high costs accrue for travel and unproductive time. In addition it is not always possible to sent the appropriate expert for a problem solution to the plant as it is not economically useful because of the high auxiliary costs and because the fault cause is not known at first.

High costs for the owner of the plant accrue as well since valuable production time is lost until an expert arrives on site and can start with the problem resolution in cases where no service expert is on site.

The underlying task of the invention is therefore to define a service system that makes it possible to significantly reduce the time for the trouble shooting—at least in part—through automated analyses and thereby to save service costs. Also it shall be possible to carry out process optimizations quickly and, through the use of a service tool, also for multiple and different plants.

This task is solved by a service system with the characteristics given in claim 1. Useful adaptations a given in the additional claims.

With the invention it is proposed to have a service server, which is connected to the automation system belonging to the plant, that is equipped to carry out analyses on its own. A display and operation station named a service client is connected to the service server over a network, either directly or via an optimization server. The optimization server too is equipped to carry out analyses of the plant and process state.

A detailed description of the invention and its advantages is given below using an adaptation example with figures.

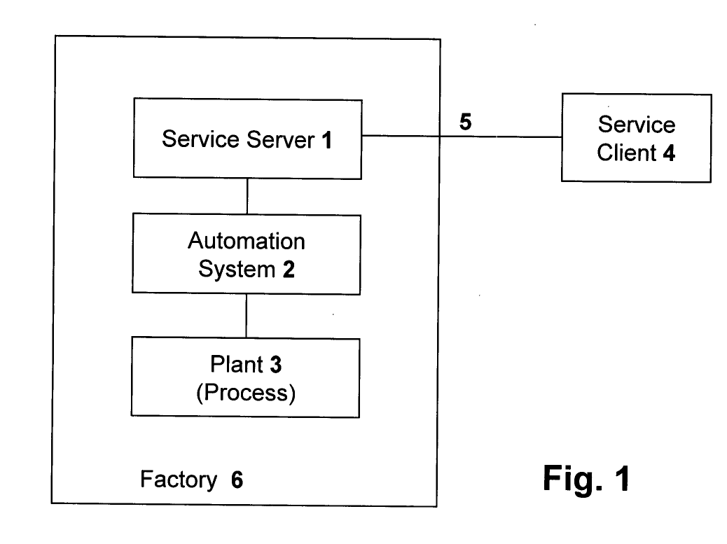

FIG. 1 shows the structure of the service systems for the variant with a single plant,

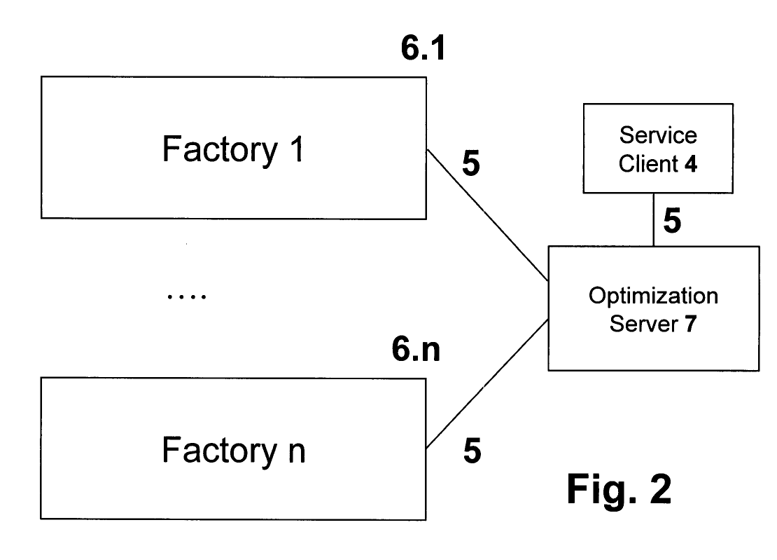

FIG. 2 shows a possible system architecture in case of multiple plants,

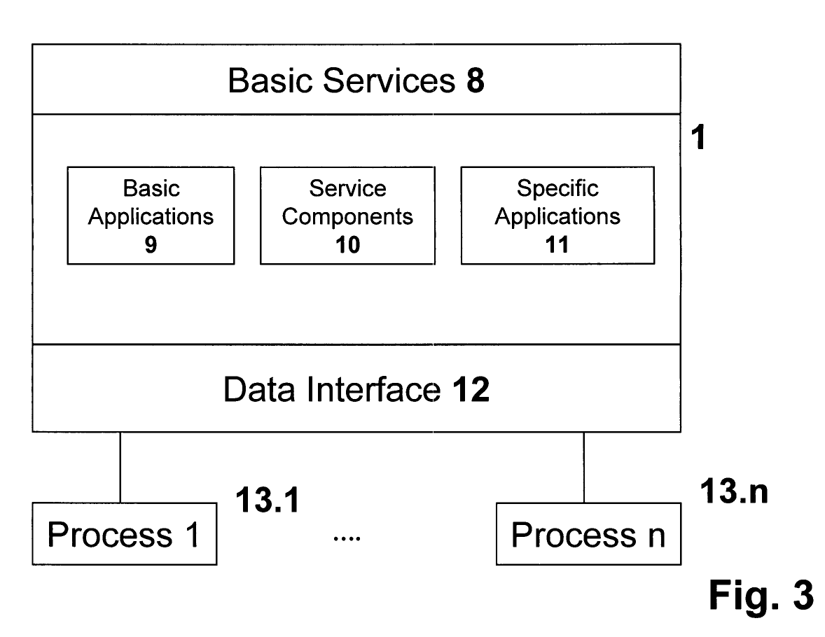

FIG. 3 shows components of the service server, and

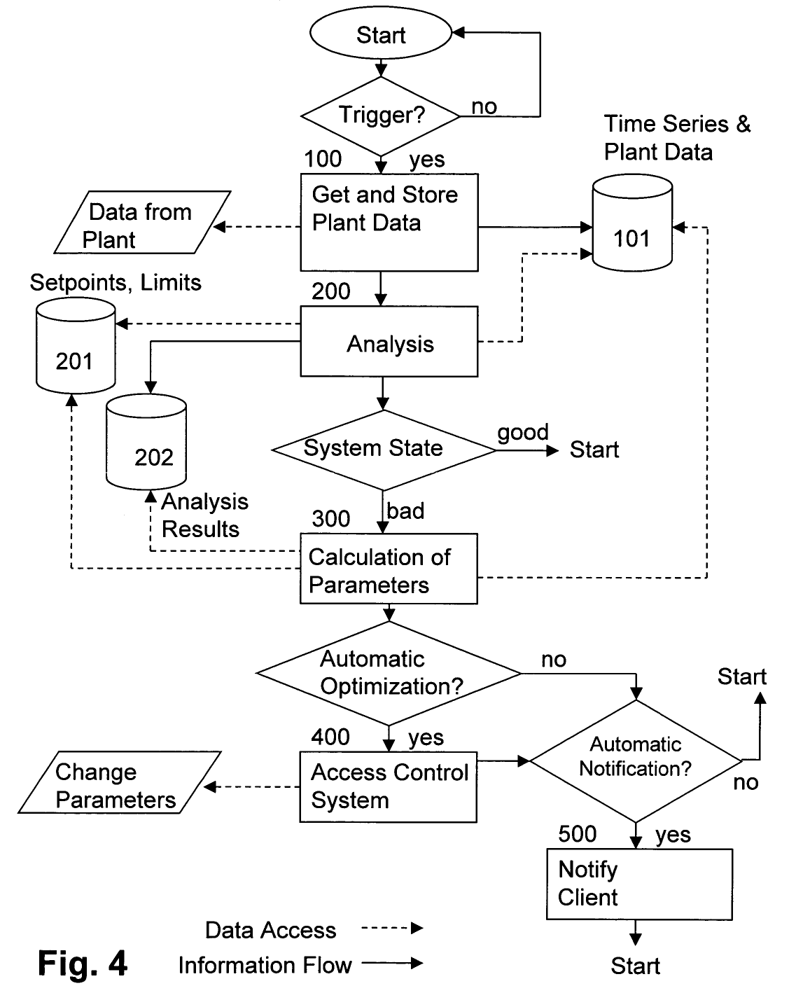

FIG. 4 shows an example of the working principle of the service system.

In FIG. 1 the system structure for a single factory 6, e.g. a paper mill or a power plant, is shown. Within such a factory a plant or machine 3 exists, which carries out one or more technical processes 13.1 to 13.n (c.f. FIG. 3). The technical plant 3 is in a customary manner connected to the automation system 2 that controls the plant 3 and collects plant-related and process-related data. This is that far a typical structure as found in almost all production plants.

Two fundamental service types can be distinguished between within such a system:

a) Service to maintain the process plant and the automation system, e.g. measures that have the goal to maintain and secure the initial operational state of the plant.

b) Service to optimize the plant (Process and Application Consulting), e.g. measures that have the goal to optimize the operation of the plant in order to for instance produce more, with less cost and/or with better quality.

For both types of service it is according to the state of the art necessary that an expert or service technician spends a large amount of his/her time directly at the site of the plant in order to carry out tasks there that make it possible to reach the above-mentioned objectives. The service technician has usually a service tool available, e.g. a computer, which has the software installed that he/she uses. This computer will be directly connected to the automation system in order to exchange data or to transfer data from data storages of the automation system to the service client.

With the invented system structure displayed in FIG. 1 the automation system 2 is connected to the service server 1. The service client 4 is or can be connected to the service server 1. The service server 1 is a computer that has a number of characteristics that enable it to carry out a remote service of automation systems and a remote process optimization.

Among these characteristics are:

The ability to display, to store, to analyze and to make available process data.

The uninitiated execution of actions, e.g. the start of applications, the sending of e-mails/SMS, the display of messages

1. after a schedule, e.g. according to a pre-determined time schedule; and/or

2. based on events, e.g. due to an alarm, a failure state, a deviation from setpoints and based on results of an analysis.

The existence of a modular system of building blocks in order to compile specific service applications at runtime from the existing components.

The availability of pre-configured basis applications that enable the user to get an overview of the state of the automation system and the process.

A process connection that is independent from the control system.

The ability to remotely operate and configure the service server.

The existence of basic services, e.g.:

user authorization, assignment of user roles, secure transmission of data to the remote clients;

the automated generation of menu structures (e.g. with main menus and sub menus and overviews in form of a Web site, personalized displays according to the user role);

notification services as e.g. e-mail and SMS.

The structure of the service server is displayed in FIG. 3:

The service server 1 is connected to the control and automation system 2 by a data interface. This data interface is divided into a control-system-independent interface and a control-system-specific implementation (not displayed in the figure). All applications access the process data by means of the control-system independent interface. Therefore it is possible to deploy applications, which run in the service server 1, without changes for different control systems 2.

Basic services 8 offer common functions as login, mail support, security, personalization, and functions for the automated generation of a menu structure of the applications running on the service server.

Basic applications 9 offer functions that facilitate an overview on the state of the automation system and of the process. These basic applications 9 can for instance display process values numerically and graphically. With that the data of the underlying control system 2 can be displayed automatically and without configuration.

Specific applications 11 can be built from single service components 10, which are available as modular building blocks from the service server. These applications can also be built from scratch using the available interfaces, such as the basic services 8 and the data interface 12.

The plant 3, the automation system 2, and the service server 1 are all situated within the factory 6 according to the proposed structure. They are connected to each other as described above. A service client 4 used by the service technician can be connected to the service server 1 using a network connection 5 in order to transfer data from the server 1 to the client 4 and to use the service server. The technician and the client 4 can be located within the plant, but foremost remote from the plant. The connection 5 between the service server 1 and the service client 4 is standardized and based on e.g. the HTTP protocol as to be connected over a number of media, e.g. local network, ISDN, modem, GSM in the intranet of the plant as well as in the Internet.

FIG. 2 shows that it is possible in extension of the structure described in FIG. 1 and FIG. 3 to connect multiple factories 6.1 to 6.n to a central optimization server 7, which is located outside of the factories. Here the single service servers 1 of the factories 6.1 to 6.n are connected to the optimization server 7 with networks 5.

The optimization server has the following characteristics:

The ability to display, store, analyze, and serve process data from the single plants 3.

The execution of these tasks can be done either dedicated for every plant 3 or together for all plants 3.

A service expert can connect his service client 4 directly to the optimization server 7 within this structure and thereby access data from multiple service servers 1 and use the optimization server.

The displayed service system allows the following work flow for the execution of remote service in automation systems and for remote process optimization.

a) Selected data are stored by the service servers, either automatically or on demand.

b) The data are:

either only collected and, or

in addition analyzed by the service server and the results of the analysis are stored, or

the data are sent to the central optimization server and analyzed there.

c) The data and/or the analysis result are compiled and made available from the service servers and/or the optimization server for the access of the service experts.

d) The data and/or the analysis result are automatically sent to the service client in order to inform the service expert, e.g. via e-mail or SMS.

e) Based on the analysis results either automatically or by the notified expert the automation system is accessed in order to

improve the process, and/or

to solve the malfunction as far as possible or to prevent it.

FIG. 4 shows an example of the working principle of the service system displayed in FIG. 1 for the execution of remote service in automation systems and for remote process optimization. In the initial state the service server 1 waits for a trigger to start the data collection. If the condition for the data collection is fulfilled, data are collected as time series from the automation system 2 in step 100 and stored for a later analysis in a database 101 of the service server 1. Conditions for the data collection are for instance:

the expiration of a determined time interval,

an input request from a user of the service server.

Afterwards the collected data are analyzed in step 200. For this at least one or multiple performance indices are calculated from the time series stored in the database 101 and compared to the setpoints for those indices 201. Such indices are for instance the variance of a process value or the maximal control deviation of a control loop. The analysis results are saved in a database 202.

If the result of the comparison is outside of the permissible limits, e.g. the system state is bad, new optimized parameters for the automation system 2 are calculated automatically in step 300. Otherwise the system returns to the initial state. Basis for these calculations are the data in the databases 101, 201, and 202 of the service server. The parameters to optimize are for instance the setpoint for a control loop or the parameters of a controller. A model of the controlled plant is determined from the collected time series for the calculation of the parameters. This model is used in order to determine new, optimized parameters using known methods for controller synthesis.

If the automatic optimization is activated, the parameter values calculated in step 300 are written to the automation system 2 in order to optimally operate the plant 3 or the process that is controlled by it.

In each case it is checked whether the automatic notification is activated. If this is the case, the service client 4 is notified about the calculated parameters and the changes that might have been applied to the automation system 2, e.g. via e-mail or SMS. Otherwise the system returns, as well as after the notification, into its initial state.

In another example the steps 200 and 300 are carried out on a central optimization server 7 (c.f. FIG. 2) with the objective to analyze and optimize multiple plants. In this case the databases 201 and 202 are located on the optimization server. Step 400 is carried out by the service servers of the single plants after the analysis and the calculation of the parameters.

1. (Canceled)

2. A service system as claimed in claim 11, wherein the data interface of the service servers is separated into a control system independent interface and a control system specific implementation.

3. A service system as claimed in claim 11, wherein the service server of multiple factories are connected by way of a network connection to said optimization server, which is set up to carry out analyses of the plant or process state.

4. A service system as claimed in claim 11, wherein the service server is set up to start the transfer of analysis results to the optimization server or to the service client automatically using the application programs.

5. A service system as claimed in claim 11, wherein the optimization server is in addition set up to carry out comparative and/or summarizing analyses over multiple industrial factories.

6. A service system as claimed in claim 11, wherein the optimization server is set up to trigger the transfer of the analysis results to the service client automatically.

7. A service system as claimed in claim 11, wherein the service server is set up to influence the automation system based on the analysis results using the application programs in order to optimize the plant or at least one of the thereby automated processes.

8. A service system as claimed in claim 11, wherein the optimization server is set up to influence at least one of the automation systems based on the analysis results using the application programs in order to optimize one of the plants or at least on of the thereby automated processes.

9. A service system as claimed in claim 11, wherein the network connection is a standardized Internet connection based on the http protocol.

10. A service system as claimed in claim 11, wherein one or multiple performance indices, which describe quality properties of the automation system and/or the automated process, are calculated on the service server or the optimization server in the context of an automated analysis.

11. A service system for remote monitoring, remote control and remote optimization of at least one technical plant and/or at least one technical plant with the associated technical process in each of said at least one technical plants, comprising:
a) a service server connected to an automation system in each of said at least one technical plants, each of said service servers comprising a data interface, basic services, and application programs;
b) an optimization server located remote from and connected by a network connection to the respective service server of each of said at least one technical plants, said optimization server connected to or connectable with a service client, said service client having operation and display means; and
c) each of said service servers set up to enable said application programs to access, to save and to process plant-based, control system based or process-based data from the respective automation system by way of the data interface and where appropriate by way of the optimization server, to transfer and display information regarding the state of the technical plant, of the automation system or the processes on the optimization server or on the service client.
